(19) United States
(12) Patent Application Publication
(10) Pub. No.: US 2021/0109479 A1
(43) Pub. Date: Apr. 15, 2021

(54) CARTRIDGE

(71) Applicant: CANON KABUSHIKI KAISHA, Tokyo (JP)

(72) Inventors: Yukio Kubo, Tokyo (JP); Masanari Morioka, Kanagawa (JP); Naoki Hayashi, Kanagawa (JP)

(21) Appl. No.: 17/126,212

(22) Filed: Dec. 18, 2020

Related U.S. Application Data
(63) Continuation of application No. PCT/JP2019/025998, filed on Jun. 25, 2019.

(30) Foreign Application Priority Data
Jun. 25, 2018 (JP) 2018-120285
Jun. 21, 2019 (JP) 2019-115774

(51) Int. Cl. G03G 21/18

(52) U.S. Cl. CPC G03G 21/1864; G03G 2221/1861; G03G 21/1814

(57) ABSTRACT

There are provided a movable member 80; a regulating member 90 movable between a regulating position for restricting movement of the movable member 80 and a non-regulating position not restricting movable member 80. By movement of the movable member 80 between a first position and a second position, a position of an end 80d of the movable member 80 in a direction of an axis L1. An end portion 80d is closer to a coupling member 63 in the direction of the axis L1 when the movable member 80 is in a second position than when it is in the first position. When the regulating member 90 is in the regulating position, the movement of the movable member 80 from the first position to the second position is restricted. When the regulating member 90 is in the non-regulating position, the movement of the movable member 80 from the first position to the second position is permitted. The movable member 80 includes a rotatable portion 81 contacting the regulating member 90 taking the regulating position.

### TECHNICAL FIELD

The present invention relates to a cartridge which can be mounted to or dismounted from an electrophotographic image forming apparatus.

### BACKGROUND OF THE INVENTION

In a laser beam printer or a copying machine as an electrophotographic image forming apparatus, a toner image its formed on a photosensitive drum and the toner image is transferred onto a sheet as a recording material to form an image on the recording material.

In such an image forming apparatus, a method in which some portions of the image forming apparatus are provided in a cartridge, and the cartridge is taken out of the main assembly of the apparatus for maintenance or replacement is widely employed in order to facilitate maintenance. U.S. Pat. No. 9,904,242 discloses a structure for mounting a cartridge in an image forming apparatus.

### SUMMARY OF THE INVENTION

### Problem to be Solved

The present invention is for providing further development of the prior art.

### Means for Solving the Problem

The present invention is a cartridge comprising a photosensitive drum; a coupling member for transmitting a driving force to said photosensitive drum; a frame rotatably supporting said photosensitive drum; a movable member movable relative to said frame; and a regulating member movable between a regulating position for regulating movement of said movable member by contacting said movable member and a non-regulating position not regulating said movable member, wherein a position of an end portion of said movable member in an axial direction of said photosensitive drum changes relative to said frame by movement of said movable member between a first position and a second position, and the end portion is closer to said coupling member in the axial direction when said movable member is in the second position than when said movable member is in the first position, and wherein when said regulating member in the regulating position, said movable member is constrained from moving from the first position to the second position, and when said regulating member is in the non-regulating position, said movable member is permitted to move from the first position to the second position, wherein said movable member is provided with a rotatable portion contacting said regulating member when said regulating member is in the regulating position.

### Effect of the Invention

According to the present invention, the prior art can be further developed.

### BRIEF DESCRIPTION OF THE DRAWINGS

FIG. 1 is a cross-sectional view of an apparatus main assembly A and a cartridge B.

FIG. 2 is a cross-sectional view of the cartridge B.

FIG. 3 is an exploded perspective view of the cartridge B.

In FIG. 4, part (a) is a perspective views of an apparatus main assembly A and the cartridge B, and part (b) is a perspective view of the device main assembly A and the cartridge B.

In FIG. 5, part (a) is a perspective view of the cartridge B, part (b) is a perspective view of the toner storage container 21 with the first side cover 25 removed, and part (c) is a perspective view of a cartridge tilting unit C.

In FIG. 6, part (a) is a perspective view of a movable guide member 80, part (b) is a perspective view of the movable guide member 80, part (c) is a perspective view of a regulation lever 90, and part (d) is a perspective view of the regulation lever 90.

In FIG. 7, part (a) is a view of the cartridge tilting unit C along the axis L4, part (b) is a view of the cartridge tilting unit C taken along the axis L4, and part (c) is a perspective view illustrating the relationship between the movable guide member 80 and the regulation lever 90, and part (d) is a perspective view illustrating the relationship between the movable guide member 80 and the regulation lever 90.

In FIG. 8, part (a) is a view of the cartridge B and the cartridge tilting unit C taken along the direction parallel to the axis L3, and part (b) is a view of the cartridge B and the cartridge tilting unit C taken along the direction parallel to the axis L3.

In FIG. 9, part (a) is an upper plan view of the cartridge B and the apparatus main assembly A, and part (b) is an upper plan view of the cartridge B and the apparatus main assembly A.

In FIG. 10, part (a) is a top plan view of the cartridge B and the apparatus main assembly A, and (b) is a top plan view of the cartridge B and the apparatus main assembly A.

In FIG. 11, part (a) is a top view of a coupling member 63 and a main assembly driving shaft 14, part (b) is a top view of the coupling member 63 and the main assembly driving shaft 14, and part (c) is a top view of the coupling member 63 and the main assembly.

In FIG. 12, part (a) is a perspective view of a neighborhood of the cartridge tilting unit C of the cartridge B as viewed from a non-driving side, and part (b) is a perspective view of a neighborhood of the cartridge tilting unit C of the cartridge B as viewed from the non-driving side.

In FIG. 13, part (a) is a perspective view of the neighborhood of the cartridge tilting unit C of the cartridge B as viewed from the non-driving side, and part (b) is a perspective view of the neighborhood of the cartridge tilting unit C of the cartridge B as viewed from the non-driving side.

In FIG. 14, part (a) is an illustration showing the relationship between the movable guide member 80 and the regulation lever 90, part (b) is an illustration showing the relationship between the movable guide member 80 and the regulation lever 90, and part (c) is an illustration showing the relationship between the movable guide member 80 and the regulation lever 90, part (d) is an illustration showing the relationship between the movable guide member 80 and the regulating lever 90, part (e) is an illustration showing the relationship between the movable guide member 80 and the regulating lever 90, and part (f) is an illustration showing the relationship between the movable guide member 80 and the regulating lever 90.

FIG. 15 is a perspective view of the cartridge 2B.

In FIG. 16, part (a) is a top view of the cartridge 2B, and part (b) is a top view of the cartridge 2B.

FIG. 17 is a perspective view of the cartridge 3B.

FIG. 18 is a view of the cartridge B as viewed along the direction parallel to the axis L3.

### EMBODIMENTS OF THE INVENTION

A cartridge and an electrophotographic image forming apparatus according to the present invention will be described with reference to the drawings. Hereinafter, a laser beam printer will be described as an example of the electrophotographic image forming apparatus, and a process cartridge usable with the laser beam printer will be described as an example of the cartridge.

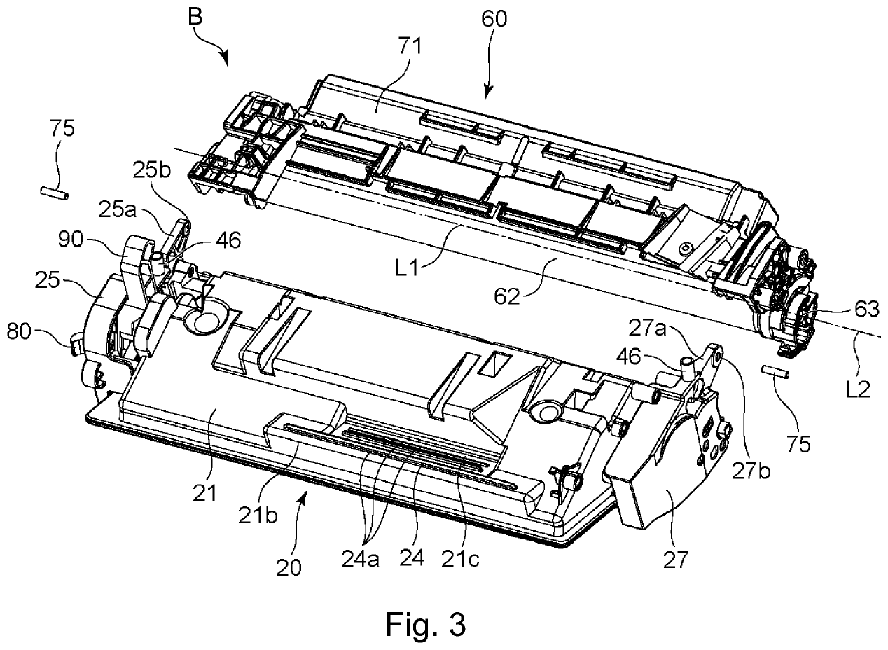

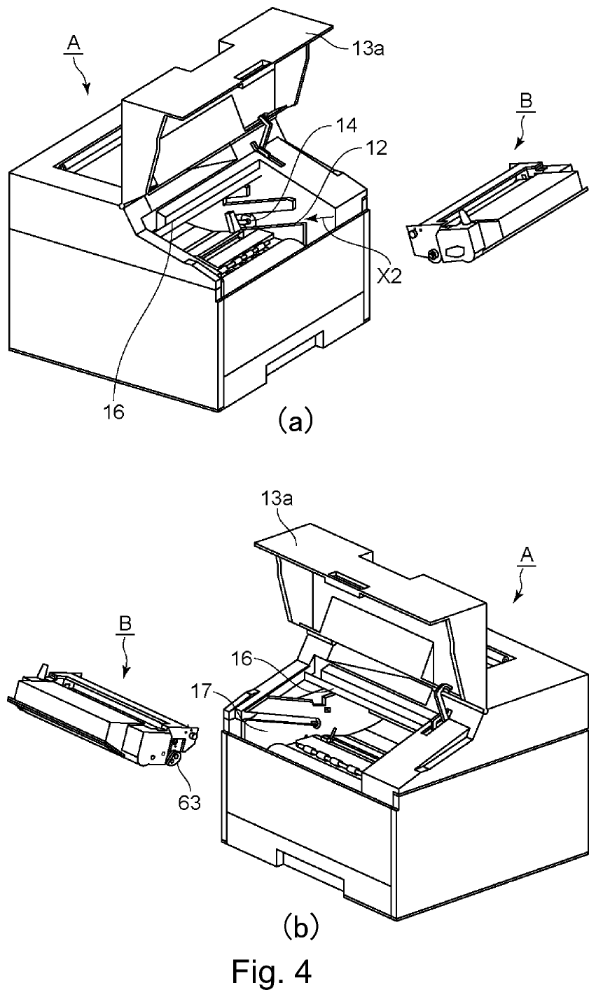

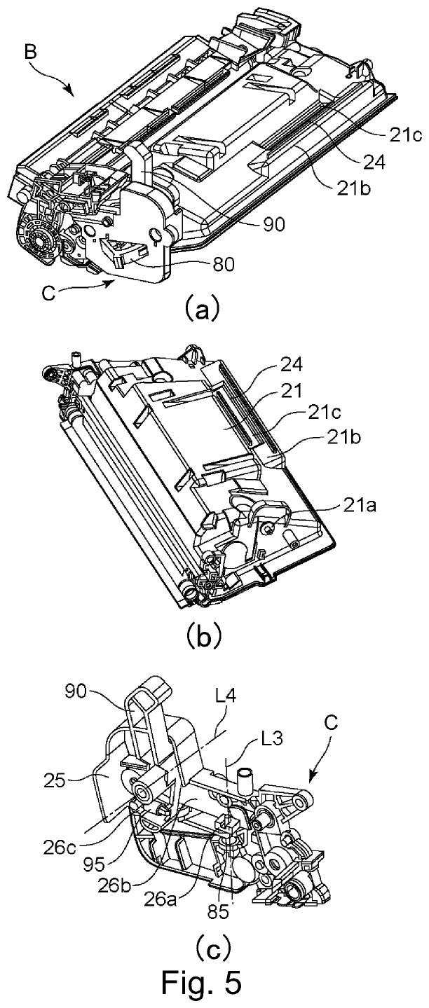

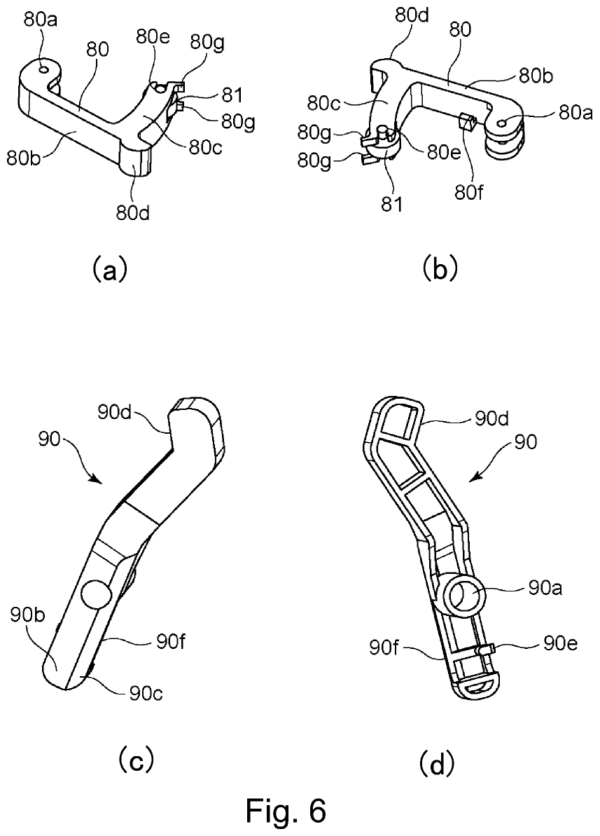

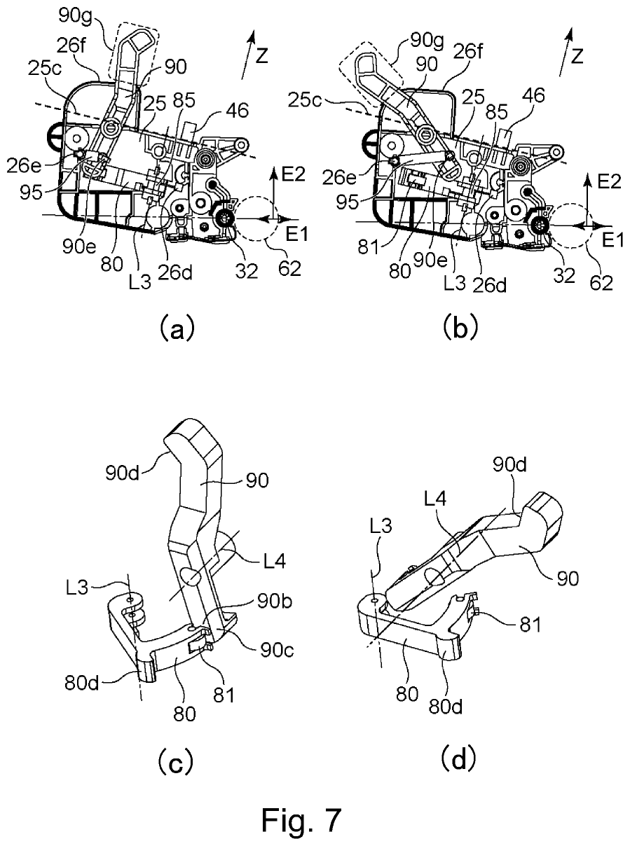

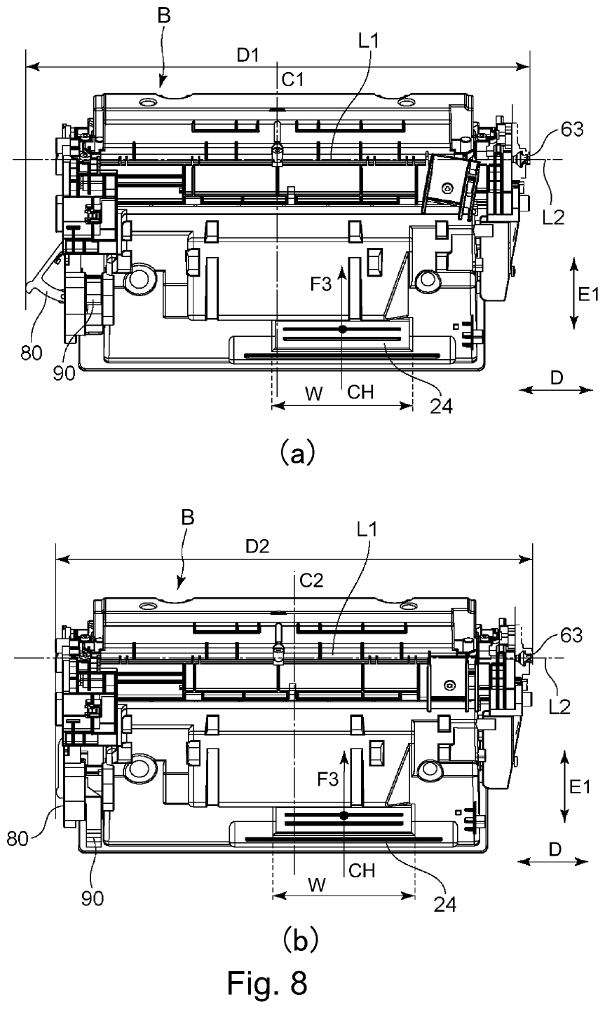

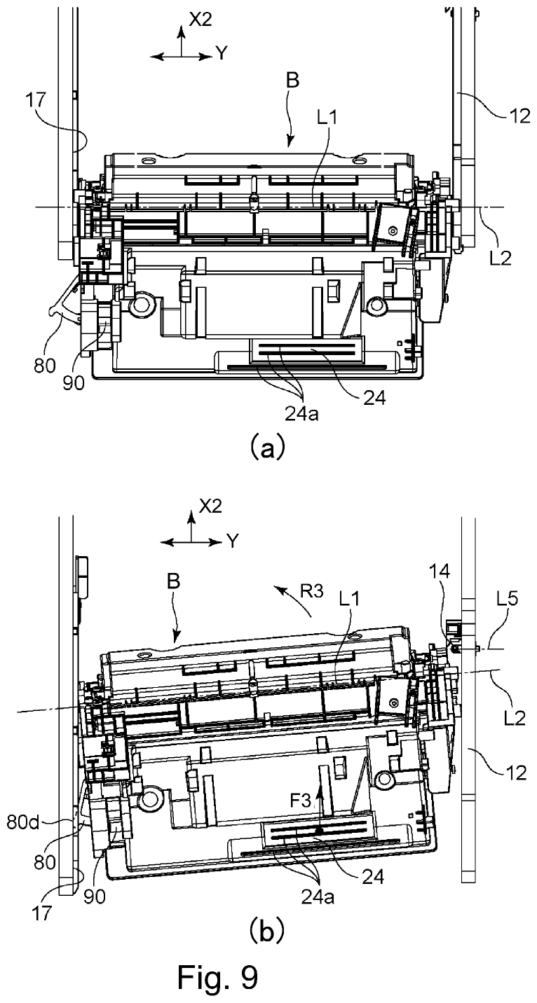

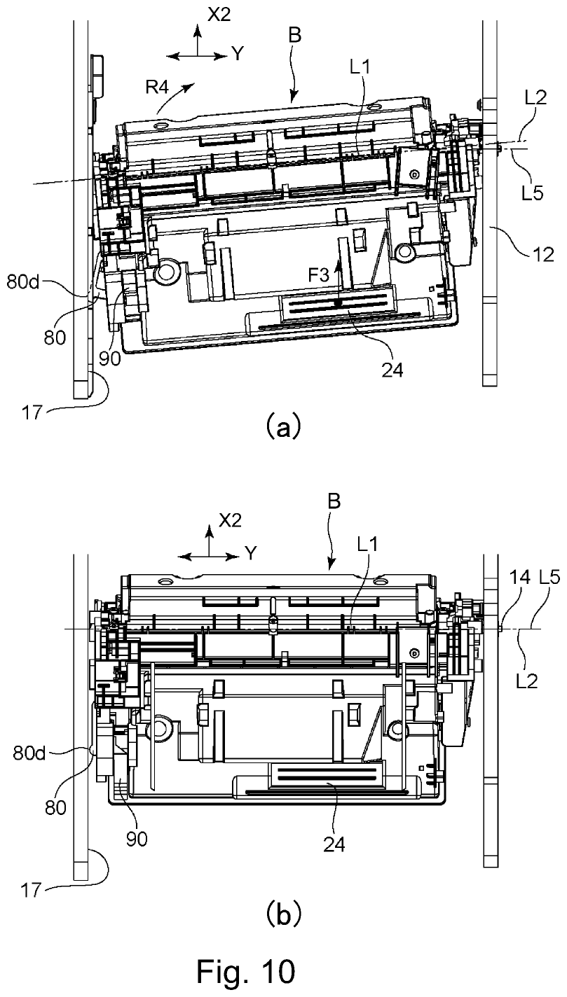

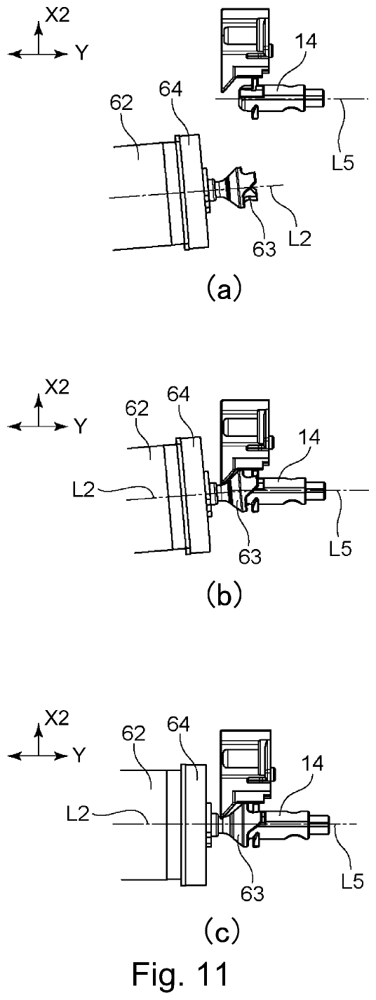

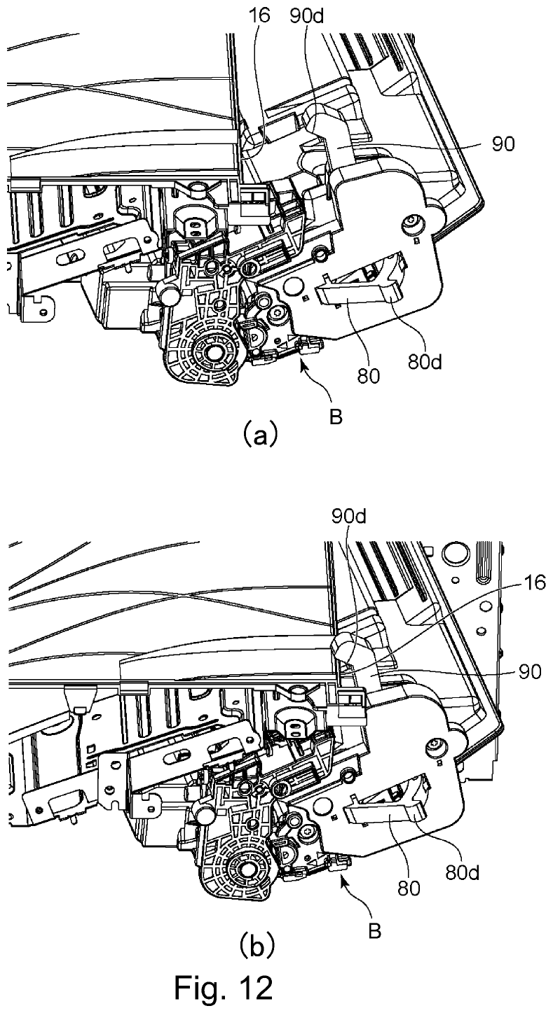

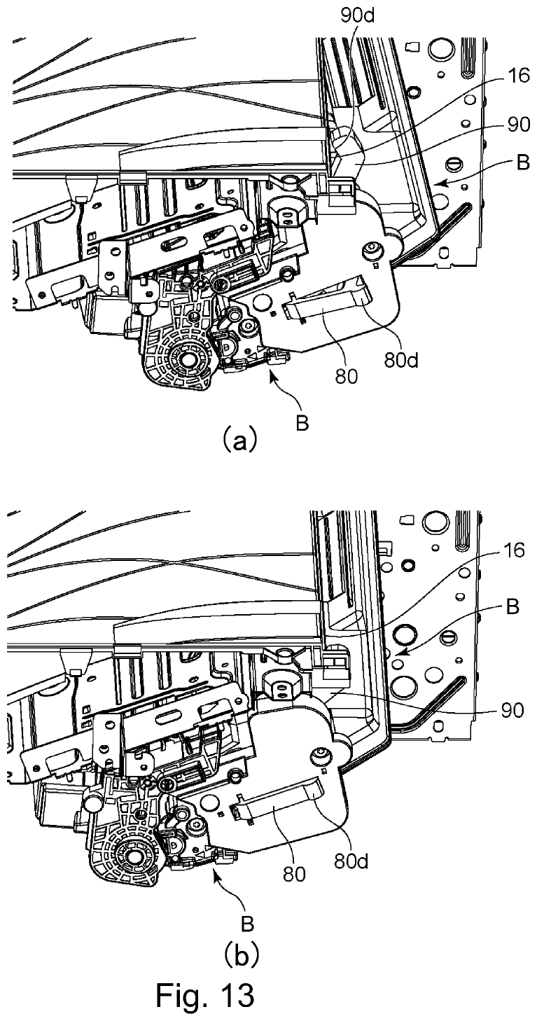

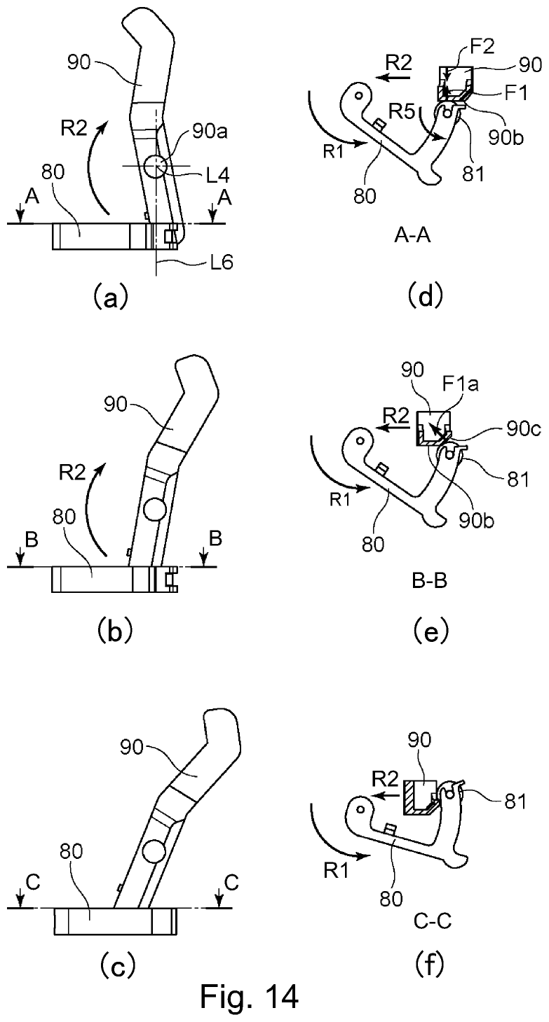

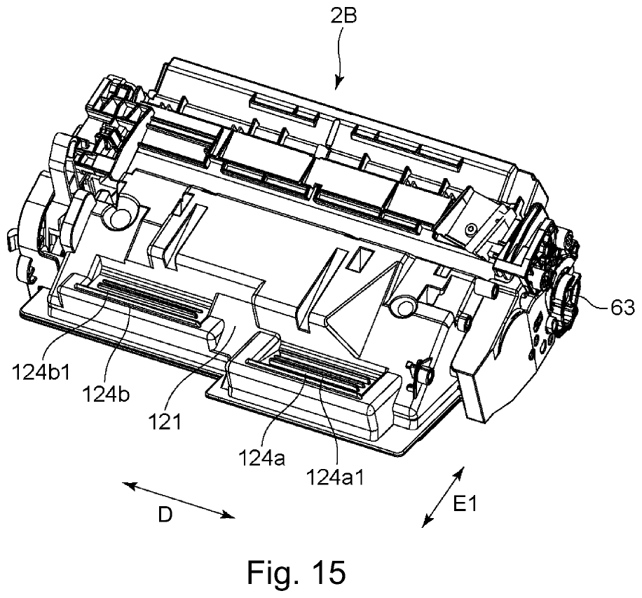

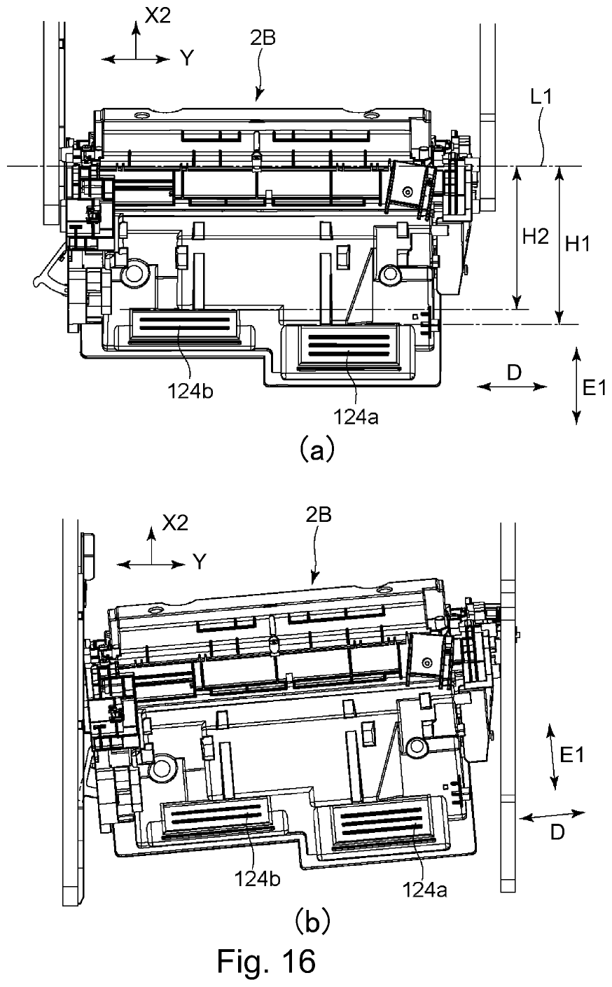

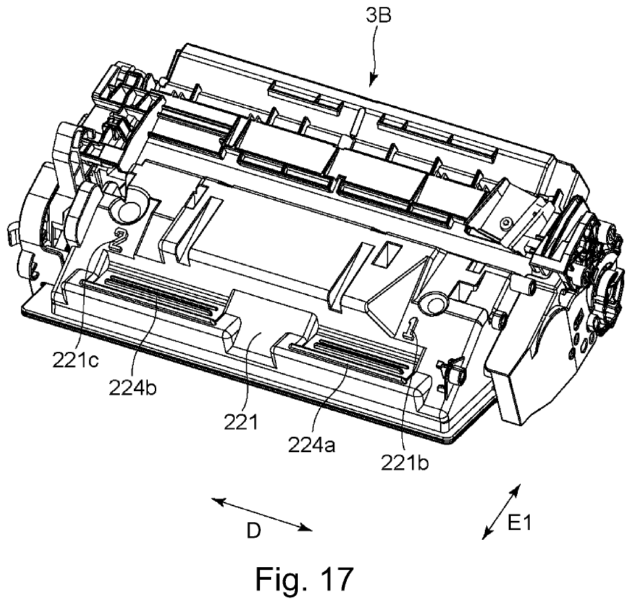

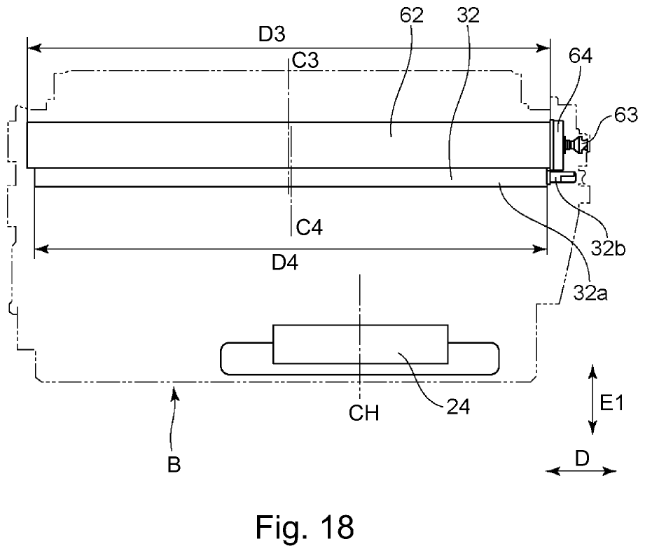

In the following description, the longitudinal direction of the cartridge is a direction substantially perpendicular to the direction in which the cartridge is mounted to and dismounted from the main assembly of the electrophotographic image forming apparatus, is parallel to the rotation axis of the electrophotographic photosensitive member drum, and is a direction intersecting the feeding direction of the recording material. In the longitudinal direction, the side on which the electrophotographic photosensitive drum receives a rotational force from the image forming apparatus main assembly is a driving side (coupling member 63 side in FIG. 3), and the opposite side is a non-driving side.

Further, reference numerals in the description are for reference to the drawings, and do not limit the structure.

### Embodiment 1

### <Electrophotographic Image Forming Apparatus Structure and Image Forming Process>

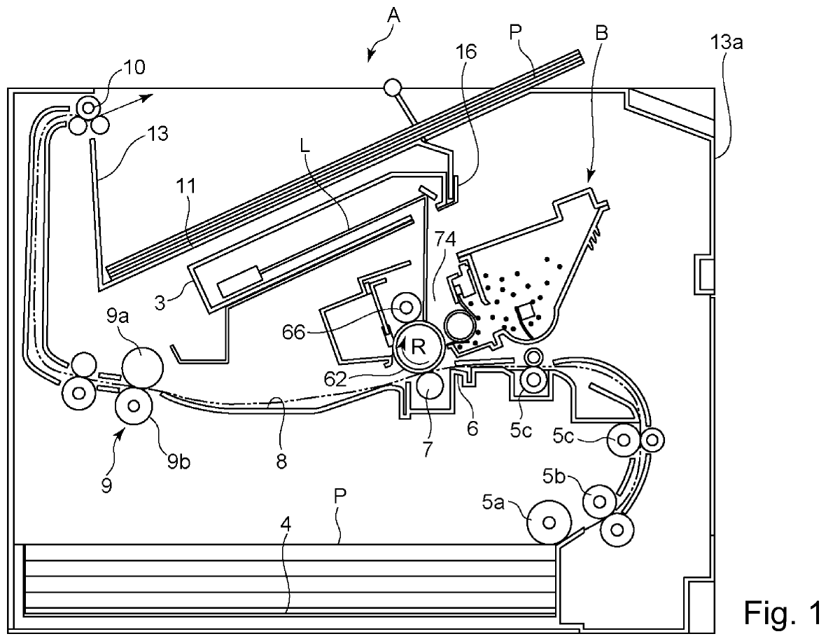

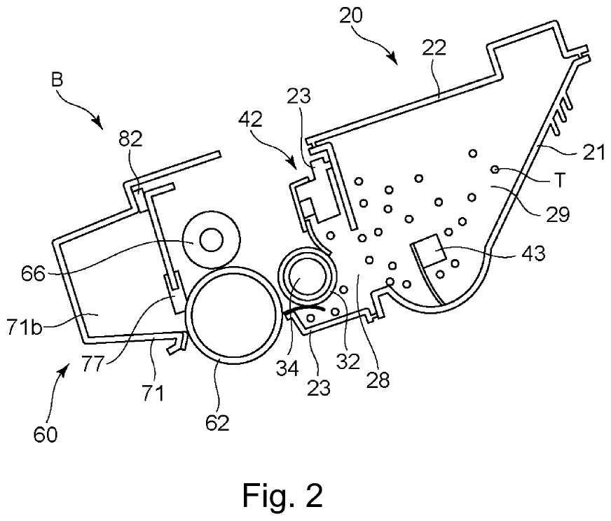

FIG. 1 is a cross-sectional view of an image forming apparatus main assembly A (hereinafter referred to as an apparatus main assembly A) and a process cartridge (hereinafter referred to as a cartridge B) of the electrophotographic image forming apparatus. FIG. 2 is a cross-sectional view of the cartridge B. Parts (a) and (b) of FIG. 4 are perspective views of the apparatus main assembly A and the cartridge B. Here, the apparatus main assembly A is a portion of the electrophotographic image forming apparatus except for the cartridge B.

Referring to FIGS. 1 and 4, the structure of the electrophotographic image forming apparatus will be described. The electrophotographic image forming apparatus shown in FIG. 1 is a laser beam printer using electrophotographic technology, in which the cartridge B can be mounted to and dismounted from the apparatus main assembly A. As shown in FIG. 4, the apparatus main assembly A has an exterior portion 13, a door 13a, a guide portion 12, a regulation release portion 16, and a guide surface 17, and the cartridge B is guided by the guide portion 12 and the guide surface 17 with the door 13a open to be mounted to and dismounted from the apparatus main assembly A.

When the cartridge B is mounted on the apparatus main assembly A, the coupling member 63 of the cartridge B engages with the driving shaft 14 provided on the apparatus main assembly A. It rotates about the rotation axis L5 of the driving shaft 14 (hereinafter referred to as the axis L5). Here, the direction parallel to the axis L5 in the apparatus main assembly A is Y direction.

Further, when the cartridge B is mounted to the apparatus main assembly A, the cartridge B is placed under the exposure device 3 (laser scanner unit). In addition, a sheet tray 4 containing recording materials (hereinafter referred to as sheets material P) to be subjected to the image formation is provided under the cartridge B. Further, the apparatus main assembly A includes a pickup roller 5a, a feeding roller pair 5b, a feed roller pair 5c, a transfer guide 6, a transfer roller 7, a feed guide 8, a fixing device 9, a discharge roller pair 10, a discharge tray 11, and the like are sequentially arranged along the feed direction D of the sheet material P. The discharge tray 11 is provided on the exterior portion 15 of the apparatus main assembly A. The fixing device 9 comprises a heating roller 9a and a pressure roller 9b.

Next, referring to FIGS. 1 and 2, the outline of the image formation process will be described. Based on the print start signal, the electrophotographic photosensitive member drum 62 (hereinafter, referred to as the drum 62), which is a rotatable member, is rotationally driven at a predetermined peripheral speed (process speed) in an arrow R direction. This is because the driving shaft 14 is rotationally driven and a driving force is transmitted to the coupling member 63, and the driving force is transmitted from the coupling member 63 (see FIGS. 3 and 4) to the drum 62.

The charging roller 66 to which the bias voltage is applied contacts the outer peripheral surface of the drum 62 and charges the outer peripheral surface of the drum 62 uniformly and uniformly. The exposure device 3 outputs a laser beam L in accordance with image information. The laser beam L passes through an exposure window portion 74 in the upper surface of the cartridge B, and scans and exposes the outer peripheral surface of the drum 62. By this, an electrostatic latent image corresponding to the image information is formed on the outer peripheral surface of the drum 62.

On the other hand, as shown in FIG. 2, in the developing unit 20 as a developing device, the developer (hereinafter referred to as “toner T”) in the toner chamber 29 is stirred and fed by rotation of a feeding member 43, so that the toner is supplied into the toner supply chamber 28. The toner T is supported on the surface of a developing roller 32 by a magnetic force of a magnet roller 34 (stationary magnet). The toner T is triboelectrically charged by a developing blade 42, and a layer thickness of the peripheral surface of a developing roller 32 is regulated. The feed member 43 and the developing roller 32 rotate by transmission of a driving force from the coupling member 63 (see FIGS. 3 and 4).

The toner T carried on the surface of the developing roller 32 is transferred (supplied) to the drum 62 in accordance with the electrostatic latent image, and is visualized into a toner image. That is, the drum 62 carries toner (toner image) and rotates.

Further, as shown in FIG. 1, the sheet material P stored in the lower portion of the apparatus main assembly A is fed from the sheet tray 4 by the pickup roller 5a, the feeding roller pair 5b, and the feed roller pair 5c in timed relation with the output timing of the laser beam L. Then, the sheet material P is supplied to a transfer position between the drum and the transfer roller 7 by way of the transfer guide 6. At this transfer position, the toner image is sequentially transferred from the drum 62 to the sheet material P.

The sheet material P onto which the toner image has been transferred is separated from the drum 62 and fed to the fixing device 9 along the feeding guide 8. Then, the sheet material P passes through a nip portion of the heating roller 9a and the pressing roller 9b constituting the fixing device 9. Pressure and heat fixing process is performed at this nip portion, and the toner image is fixed on the sheet material P. The sheet material P which has been subjected to the toner image fixing process is fed to the discharge roller pair 10 and is discharged to the discharge tray 11.

On the other hand, as shown in FIG. 2, the drum 62 after transfer is used again in the image forming process after the residual toner on the outer peripheral surface is removed by the cleaning blade 77. The toner removed from the drum 62 is stored in a waste toner chamber 71b of a cleaning unit 60.

In the above description, the charging roller 66, the developing roller 32, and the cleaning blade 77 are process means actable on the drum 62.

### <Structure Cartridge B>

Next, referring to FIGS. 2 and 3, the overall structure of the cartridge B will be described. FIG. 3 is an exploded perspective view of the cartridge B. The cartridge B is constituted by combining the cleaning unit 60 and the developing unit 20.

The cleaning unit 60 includes a cleaning frame 71, the drum 62, the charging roller 66, the cleaning blade 77, and the like.

Here, a flange 64 is fixed to the drive side end of the drum 62, and the coupling member 63 is fixed to the flange 64. Here, the drum 62 can rotate about a rotation axis L1 (hereinafter referred to as axis L1) as the drum axis. In addition, the coupling member 63 can rotate about a rotation axis L2 (hereinafter referred to as an axis L2) as a coupling axis. The axis L2 coaxial with the axis L1.

On the other hand, the developing unit 20 includes a toner accommodating container 21, a first side cover 25, a second side cover 27, the developing blade 42, the developing roller 32, the magnet roller 34, the feed member 43, toner T, a spring 46, and so on. The toner is stored in the toner accommodating container 21, and the first side cover 25 and the second side cover 27 are fixed with screws, respectively. In addition, the toner accommodating container rotatably supports the developing roller 32 and the feed member 43, and the developing blade 42 is fixed with screws.

The cartridge B is formed by rotatably connecting the cleaning unit 60 and the developing unit 20 with each other by a coupling pin 75. The cleaning frame 71, the toner storage container 21, the first side cover 25, and the second side cover 27 constitute the frame of the cartridge B. In addition, as will be understood from FIG. 3, parts (a) and (b) of FIG. 5, parts (a) and (b) FIG. 9.

A grip portion is provided for the user to grip when the user mounts the cartridge B into the apparatus main assembly. Further, on the frame (toner accommodating container 21) of the cartridge B, a projecting portion 21b projecting from the outer surface (upper surface) of the frame of the cartridge B and a recess portion 21c recessed from the outer surface (upper surface) of the frame of the cartridge B are provided. The grip portion 24 is structured to include at least portions of the surfaces of the projections 21b and recess 21c. The projection 21b and the recess 21c provides a shape (thickness) for making it easy for the user to grip the grip portion 24 to hold the frame of the cartridge B. Furthermore, the grip portion 24 has an elongated shape in the longitudinal direction of the cartridge B (the axial direction of the drum 62 or the developing roller 32). Therefore, it is easy for the user to grip the grip portion 24 and move the cartridge B in a direction perpendicular to or intersecting the axial direction of the drum 62 or the developing roller 32. Moreover, a non-slip shaped portion 24a is provided on the surface portion (grip portion zone) constituting the grip portion 24 of the projections 21b and the recesses 21c. The non-slip shaped portion 24a makes it difficult for the grip portion 24 to slip off from the user's hand by being caught by the user's fingers when the user grips the grip portion 24. In this embodiment, the non-slip shaped portion 24a includes a plurality of linear rib-shaped portions extending in parallel with each other, and the extending direction crosses with the inserting direction X2 of the cartridge B into the apparatus main body A (parts (a) and (b) of FIG. 9). However, the shape of the non-slip shape portion 24a is not limited to the above-described example, and may include a plurality of projections arranged in dots, and may be recesses arranged in dots or straight lines, for example, instead of projections. Further, the non-slip shaped portion 24a may be provided on the surface of the frame of the cartridge B without providing the projecting portion 21b or the recess portion 21c. In such a case, the region provided with the non-slip shape portion 24a on the surface of the frame of the cartridge B is the surface portion (grip portion region) constituting the grip portion 24.

More specifically, holes 25b and 27b extending in parallel with the developing roller 32 are provided in tips of arm portions 25a and 27a of the first side cover 25 and the second side cover 27 at respective ends in the longitudinal direction of the developing unit 20 (the axial direction of the developing roller 32).

Further, fitting holes 71a for fitting the coupling pins 75 are formed in each of the longitudinal end portions of the cleaning frame 71.

Then, by aligning the arm portions 25a and 27a with the predetermined positions of the cleaning frame 71 and inserting the coupling pins 75 into the rotating holes 25b and 27b and the fitting hole 71a, the cleaning unit 60 and the developing unit 20 are connected with each other so as to be rotatable about the coupling pin 75.

At this time, the springs 46 mounted on the base portions of the arm portions 25a and 27a abut the cleaning frame 71, and the developing unit 20 is urged toward the drum 62 by the developing unit 20 being urged toward the cleaning unit 60 about the coupling pin 75. Here, since ring-shaped spacing members (not shown) are mounted to the respective ends in the axial direction of the developing roller 32, the spacing members contacts the drum to maintain a predetermined gap between the developing roller 32 and the drum 62.

### <Cartridge Tilt Unit C>

Next, the cartridge tilting unit C included in the cartridge B will be described. First, the structure of the cartridge tilting unit C will be described referring to FIGS. 5 and 6. Part (a) of FIG. 5 is a perspective view of the cartridge B, part (b) of FIG. 5 is a perspective view of the toner accommodating container 21 with the first side cover 25 removed, and part (c) of FIG. 5 is a perspective view of the cartridge tilting unit C. Parts (a) and (b) FIG. 6 are perspective views of the movable guide member 80, and parts (c) and (d) of FIG. 6 are perspective views of a regulation lever 90.

The cartridge tilting unit C mainly has a movable guide member 80 and a regulation lever (regulation member) 90. The movable guide member 80 and the regulation lever 90 form a portion of the frame of the cartridge B. The cartridge tilting unit C is for tilting the axis L2 of the coupling member 63 with respect to the rotation axis L5 of the main assembly driving shaft by tilting the cartridge B when the cartridge B is mounted on the apparatus main assembly A.

In the movable guide member (moving member) 80, a supported portion 80a is rotatably supported by a support shaft 26a of the first side cover 25. The rotation axis (hereinafter referred to as axis L3) is perpendicular to the axis L1 and the axis L2 (see FIG. 3). The movable guide member 80 includes a guided portion 80d which contacts the guide surface 17 of the apparatus main assembly A, and a roller supporting portion 80e which supports a roller (rotating portion) 81. In addition, the movable guide member 80 includes a first arm 80b connecting the supported portion 80a and the guided portion 80d with each other, a second arm 80c connecting the guided portion 80d and the roller supporting portion 80e with each other, and a spring contact portion 80f provided on the first arm 80 and abutted to by the first spring 85. Further, at the free end of the second arm 80c, a positioned portion 80g which contacts a movable guide positioning portion (not shown) provided on the back surface 26b of the first side cover 25 is provided. The second arm 80c is a rod portion including an arcuately curved shape centered on the axis L3.

The regulating lever (regulating member) 90 is rotatably supported by the support shaft 21a of the toner accommodating container 21 at the supported portion 90a. The rotation axis L4 (hereinafter referred to as the axis L4) is parallel to the axis L1 and the axis L2 (see FIG. 3), and is not parallel to the axis L3 (in a twisted position). The regulation lever 90 includes a regulation surface (first surface) 90b which contacts the roller 81, an inclined surface (second surface) 90c provided next to the regulation surface (first surface) 90c, and a main assembly contact portion 90d which contacts the regulation release portion of the device main assembly A. The regulation surface 90b is perpendicular to the axis L4, and the inclined surface 90c is a surface inclined with respect to the regulation surface 90b and the axis L4. In addition, the regulation lever 90 is provided with a spring contact portion (pressed portion) 90e to which the second spring 95 abuts, and a positioned portion 90f which contacts the regulation lever positioning portion 26c of the first side cover 25.

The first side cover 25 includes the support shaft 26a described above, a back surface 26b including a movable guide positioning portion (not shown), and a regulation lever positioning portion 26c. Further, the first side cover 25 includes a first spring locking portion 26d for locking the first spring 85, a second spring locking portion 26e for locking the second spring 95, and a guide rib 26f for guiding the regulation lever 90. At least a portion of the guide rib 26f is provided at a position projecting from a surface supporting the spring 46 or an extended virtual surface 25c in the Z direction parallel to the axis L3.

Next, referring to FIGS. 7 and 8, the operation of the cartridge tilting unit C will be described. Part (a) of FIG. 7 and part (b) of FIG. 7 are illustrations of the cartridge tilting unit C as viewed along the axis L4, and part (c) of FIG. 7 and part (d) of FIG. 7 are perspective views showing a relationship between the movable guide member 80 and the regulation lever 90. part (a) of FIG. 8 and part (b) of FIG. 8 are illustrations of the cartridge B and the cartridge tilting unit C as viewed along a direction parallel to the axis L3.

Here, in part (a) of FIG. 8 and part (b) of FIG. 8, a part of the cleaning frame 71 is shown through, in order to clearly show the position of the coupling member 63.

The cartridge tilting unit C can be in a projecting state and in a retracted state. The projecting state is the state shown in part (a) of FIG. 7, part (c) of FIG. 7, and part (a) of FIG. 8, in which the movable guide member 80 is in the first position and the guided portion 80d is away from the coupling member 63 in the D direction parallel to the axis L1. A distance between the outermost end of the guided portion 80d and the outermost end of the coupling member 63 in the D direction when the movable guide member 80 is in the first position is D1.

The retracted state is the state shown in part (b) of FIG. 7, part (d) of FIG. 7, and part (b) of FIG. 8, when the movable guide member 80 is in the second position in which the guided portion 80d is in a position closer to the coupling member 63 in the D direction than when the movable guide member 80 is in the first position. A distance between the outermost end of the guided portion 80d and the outermost end of the coupling member 63 in the D direction when the movable guide member 80 is in the second position is D2.

The movable guide member 80 moves between the first position and the second position by rotating (moving) about the axis L3, and with this, the position of the guided portion 80d is also displaced. The movable guide member 80 is urged in the direction away from the second position toward the first position by the force received from the first spring 85 at the spring contact portion 80f Therefore, in a state where the cartridge B is not mounted on the apparatus main assembly A and is not subjected to an external force, the movable guide member 80 is positioned by the positioned portion 80g being abutted to the movable guide positioning portion (not shown) by the urging force of the first spring 85. At this time, it can be said that the movable guide member 80 is in the first position and the cartridge tilting unit C is in the projecting state.

On the other hand, the regulation lever 90 can move between the regulated position and the non-regulated position by rotating (moving) around the axis L4. When the movable guide member 80 is in the first position, the regulation lever 90 can be located in the regulation position. The description will be made as to the case in which the movable guide member 80 receives an external force and tends to rotate toward the second position against the urging force of the first spring 85, when the movable guide member 80 is in the first position and the regulation lever 90 is in the regulation position. At this time, the roller 81 supported by the movable guide member 80 contacts the regulation surface 90b of the regulation lever 90, and therefore, the movement of the movable guide member 80 from the first position to the second position is restricted.

The regulation lever 90 moves between the regulated position and the non-regulated position by rotating (moving) about the axis L4. Therefore, by the regulation lever 90 moving from the regulated position to the non-regulated position, the restriction on the rotations of the roller 81 and the movable guide member 80 by the regulation surface 90b is removed to permit the rotation of the movable guide member 80 from the first position to the second position.

The regulation lever 90 is pressed by the second spring 95 at the spring contact portion 90e, and is urged in the direction from the non-regulation position to the regulation position by the force received from the second spring 95. Therefore, in a state where the cartridge B is not mounted on the apparatus main assembly A and is not subjected to an external force, the positioned portion 90f of the regulation lever 90 abuts against the regulation lever positioning portion 26c by the urging force of the second spring 95 so that the regulation lever 90 is positioned at the regulated position.

As will be described in detail hereinafter, in the process of mounting the cartridge B to the device body A, the main assembly contact portion 90d receives a force from the regulation release portion of the apparatus main assembly A, by which the regulation lever 90 can move from the regulated position to the non-regulated position.

When the movable guide member 80 is in contact with the movable guide positioning portion (not shown) and is positioned there, and the regulation lever 90 is in contact with the regulation lever positioning portion 26c and is positioned there, a gap formed between the movable guide member 80 and the roller 81 and the regulation lever. Therefore, the movable guide member 80 can move toward the second position within the range of the above-described gap until the movable guide member 80 moves toward the second position by an external force and the roller 81 abuts on the regulation surface 90b. It can be said that the movable guide member 80 is in the first position even when the movable guide member 80 is in any position within this range (regulation range), that is, the movement to the second position is restricted by the regulation lever 90.

### <Position of Grip Portion 24>

Next, the position of the grip portion 24 provided on the cartridge B will be described. As shown in FIG. 8, the position of the center of the grip portion 24 in the D direction is defined as the center position CH. The center position CH is the center position of the width W of the grip portion 24 in the D direction. In addition, the center position of the width D1 of the cartridge B in the projecting state is defined as the center position C1, and the center position of the width D2 of the cartridge B in the retracted state is defined as a center position C2. Here, the width D1 of the cartridge B with respect to the D direction in the projecting state corresponds to the following distance. That is, as shown in part (a) of FIG. 8, the width D1 is from the left end (left end of the cartridge B) of the frame (movable guide member 80) of the cartridge B to the right end (right end of the cartridge B) of the frame (cleaning frame 71) of the cartridge B in the D direction. Further, the width D2 of the cartridge B with respect to the D direction in the retracted state corresponds to the following distance. That is, as shown in part (b) of FIG. 8, the width D2 corresponds to the distance from the left end (left end of the cartridge B) of the cartridge B frame (cleaning frame 71)to the right end (right end of the cartridge B) the cartridge B frame (cleaning frame) in the D direction.

Here, in the D direction, the coupling member 63 is placed on the right side (driving side) in FIG. 8 with respect to the center positions Cl and C2, and therefore, it is placed at a position closer to the right side (driving side) than to the left (non-driving side) of the cartridge B in FIG. 8. In both the projecting state and the retracted state, the center position CH in the D direction is closer to the right end (one end) of the cartridge B on the right side (drive side) than the center position C1 and the center position C2 of the cartridge B. In other words, in the D direction, the center position CH is arranged closer to the right end (one end) of the cartridge B than the left end (non-driving side) end (other end) of FIG. 8. In addition, in the D direction, it can be said that the center position CH is arranged on the side (driving side) where the coupling member 63 is arranged rather than the center position C1 and the center position C2. Further, in the D direction, the movable guide member 80 is arranged on the left side (non-driving side), in FIG. 8, of the center positions C1 and C2 in both the projecting state and the retracted state. Therefore, in the D direction, it can be said that the center position CH is arranged on the side (non-driving side) where the movable guide member 80 is not arranged, with respect to the center positions C1 and C2.

The arrangement relationship of the grip portion 24 and the coupling member 63 in the D direction is the same even when the width D3 of the drum 62 is used as a reference. FIG. 18 is a view of the cartridge B along the direction parallel to the axis L3, and shows the outer appearance of the frame of the cartridge B and the arrangement relationship of the drum 62, the developing roller 32, and the grip portion 24 for explanation. Here, the width D3 of the drum 62 is the width of the cylinder portion 62a to which the flange 64 of the drum 62 is fixed. As shown in FIG. 18, the center position of the width D3 of the drum 62 is defined as the center position C3. The center position C3 does not change irrespective of the change between the projecting state and the retracted state. Here, in the D direction, the coupling member 63 is arranged on the right side (driving side) in FIG. 18 with respect to the center position C3, and therefore, and therefore, it is placed at a position closer to the end (one end) on the right side (drive side) than to the end (other end) of the cartridge B on the left side (non-driving side) of FIG. 18. In addition, in the D direction, it can be said that the center position CH is placed on the side (driving side) where the coupling member 63 is provided with respect to the center position C3. Such a relationship is the same even if the center position C3 is the center position of the width including the width of the drum 62 plus the flange 64. Further, the above relationship is the same even if the center position C3 is replaced with the center position C4 which is the center position of the width of the developing roller 32. The width of the developing roller 32 is shown as the width of the large-diameter portion of the sleeve portion 32a of the developing roller 32 in FIG. 18, but the above relationship remains the same even if the width includes the small-diameter portion of the core metal 32b.

### <Mounting of Cartridge B to Apparatus Main Assembly A>

Next, referring to FIGS. 9, 10, 11, 12, 13 and 14, the description will be made as to the operation of the cartridge tilting unit C in the mounting process of mounting the cartridge B on the apparatus main assembly A. Part (a) of FIG. 9, part (b) of FIG. 9, part (a) of FIG. 10 and part (b) of FIG. 10 are top plan views showing the process of mounting the cartridge B in the apparatus main assembly A in the directions perpendicular to the X2 direction and the D direction. Part (a) of FIG. 11, part (b) of FIG. 11 and part (c) of FIG. 11 are top plan views showing the relationship between the coupling member 63 and the main assembly driving shaft 14 in the process of mounting the cartridge B in the apparatus main assembly A, as viewed in the direction perpendicular to the X2 and perpendicular to the D direction. Part (a) of FIG. 12, part (b) of FIG. 12, part (a) of FIG. 13 and part (b) of FIG. 13 are illustrations of the neighborhood of the cartridge tilting unit C of the cartridge B in the process of mounting the cartridge B in the apparatus main assembly A, as viewed from the non-driving side. FIG. 14 is an illustration of the relationship between the movable guide member 80 and the regulation lever 90 in the process of mounting the cartridge B in the apparatus main assembly A. Part (a) of FIG. 14, part (b) of FIG. 14 and part (c) of FIG. 14 are illustrations as viewed from the non-driving side along the axis L4. Part (d) of FIG. 14 is a cross-sectional view taken along a line A-A of part (a) of FIG. 14 as viewed along the axis L3 from the top, and part (e) of FIG. 14 is a cross-sectional view taken along a line B-B of part (b) of FIG. 14 as viewed along the axis L3 from the top, and part (f) of FIG. 14 is a cross-sectional view taken along A-A, and a cross-sectional view taken along B-B, part (f) of FIG. 14 is a cross-sectional view taken along a line C-C of part (c) of FIG. 14 as viewed from above along the axis L3.

When the user mounts the cartridge B to the apparatus main assembly A, the user inserts the cartridge B, while holding the grip portion 24, and engaging it with the guide portions 12 provided on the drive side and the non-drive side of the apparatus main assembly A, as shown in part (a) of FIG. 9. At this time, the axis L1 is perpendicular to the guide surface 17 of the apparatus main body A, and the cartridge B moves in the X2 direction which is perpendicular to the axis L1. The X2 direction is substantially parallel to the arrangement direction E1 of the rotation centers of the drum 62 and the developing roller 32. The guide surface 17 is perpendicular to the Y direction. At this time, the movable guide member 80 is in the first position. That is, the cartridge tilting unit C is in a projecting state.

As the cartridge B is further inserted, the guided portion 80d of the movable guide member comes into contact with the guide surface 17 of the apparatus main assembly A as shown in part (b) of FIG. 9. At this time, as shown in part (a) of FIG. 12, part (a) of FIG. 14 and part (d) of FIG. 14, the regulation lever 90 is in the regulation position. On the other hand, the movable guide member 80 receives a force from the guide surface 17 and receives a force to rotate in the R1 direction around the axis L3, the roller 81 contacts the regulation surface 90b, and the regulation surface 90b receives a force F1 from the roller 81. The regulation lever 90 contacts to and restricted by the first side cover 25 to receive the reaction force F2, and therefore, it cannot move in the direction of the force Fl. Therefore, the movable guide member 80 is restricted from moving to the second position and is maintained in the first position. Therefore, in the cartridge B, by the guided portion 80d of the movable guide member 80 contacting the guide surface 17, the axis L1 becomes inclined with respect to the guide surface 17 of the apparatus main assembly A and the Y direction, and as shown in part (a) of FIG. 11, the axis L2 becomes in an inclined state with respect to the axis L5. At this time, as shown in part (b) of FIG. 9, a force F3 imparted by the user inserting the cartridge B while holding the grip portion 24 produces a moment in a direction of rotating the cartridge B in a direction R3 (counterclockwise in part (b) of FIG. 9 about the guided portion 80d. Therefore, the cartridge B is inserted into the apparatus main assembly A in a state that the drive side portion of the cartridge B precedes the non-drive side portion in the inserting direction X2.

When the user further inserts the cartridge B into the apparatus main assembly A, the cartridge B moves in the X2 direction while keeping the state in which the axis L1 is inclined with respect to the guide surface 17 of the apparatus main assembly A and the Y direction. Then, as shown in part (b) of FIG. 12, the main assembly contact portion 90d of the regulation lever 90 starts contacting the regulation release portion 16 of the device main assembly A. At this time, since the regulation lever 90 is in the regulation position, the movable guide member 80 is maintained in the first position. Further at this time, as shown in part (a) of FIG. 10, the cartridge B is in a state that the axis L1 is inclined with respect to the guide surface 17 and the Y direction. Then, as shown in part (b) of FIG. 11, the coupling member 63 and the main assembly driving shaft 14 come into contact to each other while the axis L2 is inclined with respect to the axis L5, and the movement of the coupling member 63 in the X2 direction is restricted.

When the user further inserts the cartridge B into the device main assembly A, as shown in part (a) of FIG. 13, the main assembly contact portion 90d of the regulation lever 90 is in contact with the regulation release portion 16 of the apparatus main assembly A, and therefore, the regulation lever 90 rotates in the R2 direction about the axis L4 toward the non-regulation position. At this time, as shown in part (a) of FIG. 14 and part (d) of FIG. 14, when the regulation surface 90b moves in the R2 direction, the roller 81 rotates in R5 direction about the rotational axis L6 (axis L6). As shown in part (a) of FIG. 14, the arrangement is such that when the regulation lever 90 is in the regulation position, as viewed in the direction along the axis L4, an extension line of the axis L6 of the roller 81 overlaps with the supported portion 90a, and further with the axis L4, in this embodiment. Therefore, as compared with the structure in which the movable guide member 80 and the regulation surface 90b are in direct contact with each other not through the roller 81 with generation of frictional resistance, the above-described structure is effective to reduce the resistance against the movement of the regulation surface 90b in the direction R2 produced by the contact between the roller 81 and the regulation surface 90b.

As the regulation lever 90 further rotates in the R2 direction, the roller 81 comes into contact with the inclined surface 90c as shown in part (b) of FIG. 14 and part (e) of FIG. 14. The inclined surface 90c is inclined with respect to the axis L4 of the regulation lever 90 and the surface perpendicular to the axis L4. Therefore, the inclined surface 90c receives the force F1a from the roller 81, and the component force of the force Fla in the direction parallel to the R2 direction acts on the regulation lever 90 to rotate the regulation lever 90 in the R2 direction. In this manner, the regulating lever 90 comes into contact with the movable guide member 80 and the roller 81 while moving from the regulated position to the non-regulated position.

When the user further inserts the cartridge B into the apparatus main assembly A, the regulation lever 90 is moved to the non-regulated position, and the movable guide member 80 is moved to the second position by way of the states shown in part (c) of FIG. 14 and part (f) of FIG. 14. At this time, the coupling member 63 in is contact with the main assembly driving shaft 14 and is prevented from moving in the X2 direction. Therefore, as shown in part (a) of FIG. 10, the cartridge B rotates in the R4 direction about the contact portion between the main assembly driving shaft and the coupling member 63 by the force F3 applied to the grip portion 24 by the user (clockwise direction in part (a) of FIG. 10). By this rotation, the coupling member 63 is brought into engagement with the main assembly driving shaft 14 while circumventing it.

Finally, as shown in part (b) of FIG. 10 and part (b) of FIG. 13, the axis L1 of the cartridge B becomes perpendicular to the guide surface 17 of the apparatus main assembly A and parallel to the Y direction. The cartridge tilting unit C becomes in the retracted state. At this time, as shown in part (c) of FIG. 11, the axis L2 is coaxial (parallel) with the axis L5, and the coupling member 63 and the main assembly driving shaft 14 are engaged with each other. This completes the mounting of the cartridge B in the device main assembly A.

<Dismounting of Cartridge B from Apparatus Main Assembly A>

In the removal step of dismounting the cartridge B from the apparatus main assembly A, the above-described mounting steps are carried out in the reverse order. When the cartridge B changes from the state shown in part (b) of FIG. 10 to the state shown in part (b) of FIG. 10, the movable guide member 80 moves from the second position to the first position by the urging force of the first spring 85. By this, the regulating lever 90 rotates from the non-regulated position shown in part (b) of FIG. 7 to the regulated position shown in part (a) of FIG. 7 by the urging force of the second spring 95 in the direction opposite to the R2 direction. By this, the cartridge tilting unit C returns to the projecting state.

As shown in part (a) of FIG. 7 and part (b) of FIG. 7, a direction E2 is defined as the direction perpendicular to the direction E1 in which the rotation center of the drum 62 and the rotation center of the developing roller 32 are aligned as viewed along the axis L4. The portion of the lever 90 projecting from the first side cover 25 is a projecting portion 90g. The second spring 95 for urging the regulation lever 90 is a tension coil spring stretched between the spring contact portion 90e and the second spring locking portion 26e, and the central axis of the coil is not parallel to the axis L4 (in a twisted relation).

Further, as viewed along the axis L4, with respect to the direction E2, the spring contact portion 90e and the second spring locking portion 26e are located on the opposite side of the main assembly contact portion 90d and the projecting portion 90g with respect to the supported portion 90a (axis line L4). In addition, as viewed along the axis L4, the spring contact portion 90e and the second spring locking portion 26e are located on the opposite side of the main assembly contact portion 90d and the projecting portion 90ge with respect to the supported portion 90a (axis line L4), in the Z direction (direction parallel to the axis L3).

With the above-described structure of the second spring 95 and the arrangement of the spring contact portion 90e and the second spring locking portion 26e, the urging force of the second spring 95 can be assuredly caused to act on the regulation lever 90 during the regulating lever 90 moving from the non-regulated position to the regulated position.

As described above, according to this embodiment, the mountability of the cartridge B can be improved in the structure in which the cartridge B is mounted on the apparatus main assembly A while inclining the axis L1.

Specifically, the center line CH of the grip portion 24 in the D direction is on the coupling member 63 side (driving side) with respect to the center line C1 and the center line C2 of the cartridge B in the D direction in both the projecting state and the retracted state. By this, when the cartridge B is inserted, it is possible to more reliably create a state in which the axis L1 shown in FIG. 9sf(b) is inclined with respect to the Y direction. In addition, as shown in FIG. 8, the grip portion 24 is arranged so that the central position CH is in the width W range in the D direction in both the projecting state and the retracted state. By this, it is possible to prevent the axis L1 from being tilted more than necessary with respect to the Y direction when the cartridge B is inserted.

Further, in the case that the movable guide member 80 and the regulation surface 90b are in direct contact with each other to generate frictional resistance without providing the roller 81, the regulation lever 90 is sandwiched between the movable guide member 80 and the first side cover 25 with the result of the production of a frictional forces relative to the two members. In the case of such a structure, there is a possibility that it cannot rotate smoothly in the R2 direction. However, by providing the roller 81 at the portion of the movable guide member 80 which contacts the regulation lever 90, the roller 81 in contact with the regulation surface 90b can rotate in the R5 direction while the regulation lever 90 is rotating from the regulated position to the non-regulation position in the R2 direction. Therefore, the resistance of the movement (rotation) of the regulation lever 90 can be reduced, and the regulation lever 90 can be smoothly moved (rotated) from the regulated position to the non-regulated position.

Further, by providing the regulating lever 90 with the inclined surface 90c, the force received by the movable guide member 80 from the guide surface 17 to move the movable guide member 80 from the first position to the second position is effective to cause the regulating lever 90 to move in the R2 direction. By this, the rotation (movement) of the regulation lever 90 from the regulated position to the non-regulated position in the R2 direction can be performed more smoothly.

### Embodiment 2

Next, Embodiment 2 of the present invention will be described. In the description of this embodiment, the description of the portions common to the Embodiment 1 will be omitted. In this embodiment, the structure of the grip portion provided on the cartridge 2B is different from that of the Embodiment 1, and in the other respects, it is the same as the cartridge B of the Embodiment 1. FIG. 15 is a perspective view of the cartridge 2B, and part (a) of FIG. 16 and part (b) of FIG. 16 are top plan views of the cartridge 2B as viewed along the directions perpendicular to the X2 direction and the D direction.

A toner accommodating container 121 of the cartridge 2B has a first grip portion 124a and a second grip portion 124b. Each of the first grip portion 124a and the second grip portion 124b includes a first non-slip portion 124a1 and a second non-slip portion 124b1 functioning as anti-slip portion when gripped by the user. The first non-slip portion 124a1 and the second non-slip portion 124b1 each comprises a plurality of ribs or grooves extending in the D direction.

The first grip portion 124a and the second grip portion 124b are arranged at different positions in the D direction, and the first grip portion 124a is placed closer to the driving side end where a coupling member 63 of the cartridge B is provided than the second grip portion 124b. Further, as shown in FIG. 16, when comparing the distances H1 and H2 from the axis L1 to the first grip portion 124a and the second grip portion 124b with respect to the inserting direction X2 (or E1 direction) of the cartridge 2B, the distance H1 is longer than the distance H2. That is, in the X2 direction (or the E1 direction), the first grip portion 124a is at a position more remote from the axis L1 than the second grip portion 124b.

Therefore, when the cartridge 2B is started to be inserted into the apparatus main assembly A in the X2 direction as shown in part (a) of FIG. 16, the first grip portion 124a is on the upstream side of the second grip portion 124b in the X2 direction. By this, the user can be more likely to grip the first grip portion 124a which is closer to himself or herself than the second grip portion 124b and to insert the cartridge B. A moment in the direction of rotating the cartridge 2B in the R3 direction (counterclockwise direction in FIG. 9B) about the guided portion 80d is produced by the force F3 applied by the user to insert the cartridge 2B while holding the first grip portion 124a. Therefore, the cartridge 2B is inserted into the apparatus main assembly A in a state in which the drive-side portion of the cartridge 2B precedes the non-drive-side portion in the inserting direction X2, that is, in a state where the axis L1 is inclined with respect to the axis L2.

Then, as shown in part (b) of FIG. 16, the coupling member 63 is brought into contact to the main assembly driving shaft 14 while the axis L2 is inclined with respect to the axis L5, the movement of the coupling member 63 in the X2 direction is restricted, similarly to the case of part (a) of FIG. 10. Thereafter, the user grips the second grip portion 124b and inserts the cartridge 2B, so that the cartridge 2B rotates in the R4 direction about the contact portion between the main body driving shaft 14 and the coupling member 63. Through such an operation, the cartridge 2B can be completely mounted in the apparatus main assembly A.

In this embodiment described above, the structure in which the first grip portion 124a and the second grip portion 124b are provided apart from each other has been described, but the present invention is not limited to this example. That is, a portion of the first grip portion 124a and a portion of the second grip portion 124b may be common. The structure in which portions of the two grip portions are common means a structure in which a specific portion of the surface of the toner accommodating container 121 is a portion of the first grip portion 124a and also a portion of the second grip portion 124b. In such a case, it will suffice if at least a portion of the first grip portion 124a may have a portion arranged upstream of the second grip portion 124b, with respect to the inserting direction X2.

Further, in the above-described embodiment, at least a portion of the first grip portion 124a has a portion arranged upstream of the second grip portion 124b, with respect to the inserting direction X2, but the present invention is not limited to such an example. That is, if a portion of the first grip portion 124a and a portion of the second grip portion 124b are not common, it will suffice if at least a portion of the first grip portion 124a does not have a portion upstream of the second grip portion 124b in the inserting direction X2. Such an arrangement of the grip portions includes an arrangement in which there is no provision of any one of the first grip portion 124a and the second grip portion 124b in the E1 direction, and the examples of such a structure is shown in the first grip portion 224a and the second grip portion 224b in FIG. 17.

Further, in the above-described embodiment, the plurality of ribs or grooves provided in the first non-slip portion 124a1 and the second non-slip portion 124b1 each have a shape extending in the D direction, but the present invention is not limited to such an example. For example, the extending directions of the plurality of ribs or grooves provided in the first nonslip portion 124a1 and the second non-slip portion 124b1 may be different from each other. Specifically, the extending direction of the plurality of ribs or grooves of the first nonslip portion 124a1 may be the direction inclined in the D direction, and the extending direction of the plurality of ribs or grooves of the second non-slip portion 124b11 may be the D direction. By doing so, it is easy to inform the user that the first grip portion 124a and the second grip portion 124b are gripped at different timings of the cartridge attitude.

As described above, by providing the first grip portion 124a and the second grip portion 124b, the mountability of the cartridge 2B can be improved in the structure in the cartridge B is mounted in the apparatus main assembly A with the axis L1 tilted.

### Embodiment 3

Next, Embodiment 3 of the present invention will be described. In the description of the present embodiment, the description of the portions common to the Embodiment 1 and the Embodiment 2 will be omitted. In this embodiment, the structure of the grip portion provided on the cartridge 3B is different from that in the Embodiment 2, and in the other respects, it is the same as the cartridge 2B in the Embodiment 2. FIG. 17 is a perspective view of the cartridge 3B.

In this embodiment, as shown in FIG. 17, the toner accommodating container 221 includes a display portion which indicates to the user the order in which the first grip portion 224a and the second grip portion 224b are gripped. Specifically, the first display portion 221b is provided near the first grip portion 224a, and the second display portion 221c is provided near the second grip portion 224b. Therefore, when the cartridge 3B is mounted to the device main body, the user can be guided to first grip the first grip portion 224a. This makes it easier for the user to insert the cartridge 3B in a state in which the drive-side portion of the cartridge 3B precedes the non-drive-side portion in the inserting direction X2 (that is, the axis L1 is inclined with respect to the axis L2).

Then, as in part (b) of FIG. 16, while the axis L2 is inclined with respect to the axis L5, the coupling member 63 and the main assembly driving shaft 14 are brought into contact with each other, and the movement of the coupling member 63 in the X2 direction is restricted, and thereafter, it is possible to induce the user to grip the second grip portion 224b. By this, the cartridge 2B can be completely mounted on the device main assembly A by rotating in the R4 direction about the contact portion between the main assembly driving shaft 14 and the coupling member 63.

The first display unit 221b may have at least a portion thereof arranged on the first grip portion 224a, and the second display unit 221c may have at least a portion thereof arranged on the second grip portion 224b. Further, the characters displayed by the first display portion 221b and the second display portion 221c are not limited to Arabic numerals as long as they can indicate the order of gripping, but other numbers (Roman numerals, for example) and characters or symbols indicating the order (“FIRST” and other words, sentences or the like).

As described above, the display portions (first display portion 221b and second display portion 221c) will suffice if it indicates to the user the order in which the first grip portion 224a and the second grip portion 224b are gripped. Further, unlike the first display portion 221b and the second display portion 221c, they may not be arranged apart from each other and may be displayed together in one place.

Further, the display method of the first display portion 221b and the second display portion 221c is not limited to the examples in which characters are three-dimensionally formed on the surface of the toner accommodating container 221 by pits or projections. For example, a sticker or member on which characters are printed may be mounted or fixed to the surface of the toner accommodating container 221, it may be marked with ink or the like, or may be engraved with a laser or an engraving tool.

Further, in the above-described embodiments, the structure in which the first grip portion 224a and the second grip portion 224b are provided apart from each other has been described, but the structure of the first grip portion 224a and the second grip portion 224b is not limited to such an example. That is, a portion of the first grip portion 224a and a portion of the second grip portion 224b may be common. That is, a specific portion of the surface of the toner accommodating container 221 may be a portion of the first grip portion 224a and also a portion of the second grip portion 224b. Further, one grip portion including a portion on the drive side (corresponding to the first grip portion 224a) and a portion on the non-drive side (corresponding to the second grip portion 224b) with respect to the center position C1 (not shown) and the center position C2 (not shown) in the D direction. That is, even when one grip portion has a portion corresponding to the first grip portion 224a and the second grip portion 224b, it can be said that the structure has the first grip portion 224a and the second grip portion 224b. The center position C1 and the center position C2 in this embodiment have the same definitions as those in Embodiment 1.

As described above, in this embodiment, two grip portions (first grip portion 224a, second grip portion 224b) are provided, and display portions (first display portion 221b, second display portion 221c) corresponding to them are provided. By this, in the structure in which the cartridge B is mounted on the apparatus main assembly A by inclining the axis L1, the mountability of the cartridge 2B can be improved.

Further, the first display portion 221b and the second display portion 221c of the present embodiment may be added to the structure of Embodiment 2.

Further, the cartridge B described in each of Embodiments 1-3 has a structure including a drum 62 and a coupling member 63 for transmitting a driving force to the drum 62, but the structure of the cartridge B and the object to receive the driving force through the coupling member 63 is not limited to the drum 62.

That is, the cartridge B may not have the drum 62, or the coupling member 63 may not transmit the driving force to the drum 62 but transmit the driving force to the developing roller 32 or the like.

### INDUSTRIAL APPLICABILITY

According to the present invention, there is provided a cartridge which can be mounted to or dismounted from an electrophotographic image forming apparatus, which represents further development of the prior art.

The present invention is not limited to the above-described embodiment, and various modifications and modifications can be made without departing from the spirit and scope of the present invention.

Therefore, the following claims are provided in order to publicize the scope of the present invention.

This application claims priority on the basis of Japanese Patent Application Japanese Patent Application No. 2018-120285 filed on Jun. 25, 2018 and Japanese Patent Application No. 2019-115774 filed on Jun. 21, 2019. All of the contents of them are incorporated here.

1. A cartridge comprising:
a photosensitive drum;
a coupling member for transmitting a driving force to the photosensitive drum;
a frame rotatably supporting the photosensitive drum;
a movable member movable relative to the frame; and
a regulating member movable between a regulating position for regulating movement of the movable member by contacting the movable member and a non-regulating position where the moveable member does regulate the movable member,
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position, and
wherein, when the regulating member is in the regulating position, the movable member is constrained from moving from the first position to the second position, and when the regulating member is in the non-regulating position, the movable member is permitted to move from the first position to the second position,
wherein the movable member is provided with a rotatable portion contacting the regulating member when the regulating member is in the regulating position.

2. A cartridge according to claim 1, wherein the rotatable portion is rotatable while being in contact with the regulating member moving from the regulating position toward the non-regulating position.

3. A cartridge according to claim 1, wherein the regulating member moves between the regulating position and the non-regulating position by rotation thereof

4. A cartridge according to claim 3, further comprising a developing roller for supplying toner to the photosensitive drum, and a spring for moving the regulating member from the non-regulating position to the regulating position,
wherein the regulating member is provided with an urged portion urged by the spring and a projected portion projected from the frame, and
wherein, as viewed along a direction of a rotational axis of the regulating member, the urged portion is positioned on a side opposite from the projected portion with respect to the rotational axis of the regulating member in a first direction perpendicular to a direction in of a rotational axis of the photosensitive drum and a rotational axis of the developing roller.

5. A cartridge according to claim 4, wherein the spring is a tension coil spring.

6. A cartridge according to claim 5, wherein the tension coil spring has a center axis that is not parallel to a rotational axis of the regulating member.

7. A cartridge according to claim 3, wherein the regulating member has a first surface contacting the movable member when the regulating member is in the regulating position, and a second surface contacting the movable member in midstream of movement from the regulating position to the non-regulating position, and
wherein the first surface is substantially perpendicular a rotational axis of the regulating member, and the second surface is inclined relative to the first surface and the rotational axis of the regulating member.

8. A cartridge according to claim 1, wherein the cartridge is mountable to an image forming apparatus, and the coupling member is positioned closer to one end portion of the frame than to the other end portion in an axial direction of the photosensitive drum, and
wherein the frame is provided with a grip portion to be gripped when the cartridge is mounted to the image forming apparatus, and
wherein a center of the grip portion is closer to the one end portion than to the other end potion of the frame.

9. A cartridge according to claim 1, wherein the cartridge is mountable to an image forming apparatus, and the cartridge includes a developing roller for carrying toner to be supplied to the photosensitive drum,
wherein the coupling member is positioned closer to one end portion of the frame than to the other end portion in an axial direction of the photosensitive drum,
wherein the frame is provided with a first grip portion and a second grip portion to be gripped when the cartridge is mounted to the image forming apparatus,
wherein the first grip portion is positioned closer to the one end portion than the second grip portion, and
wherein the first grip portion is positioned more remote from an axis of the photosensitive drum than the second grip portion in a direction in which a rotational axis of the photosensitive drum and a rotational axis of the developing roller are arranged.

10. A cartridge according to claim 9, wherein the frame is provided with a display portion indicative of an order of gripping the first grip portion and the second grip portion.

11. A cartridge according to claim 1, wherein the cartridge is mountable to an image forming apparatus, and the coupling member is positioned closer to one end portion of the frame than to the other end portion in an axial direction of the photosensitive drum,
wherein the frame is provided with a first grip portion and a second grip portion to be gripped when the cartridge is mounted to the image forming apparatus,
wherein the first grip portion is positioned closer to the one end portion than the second grip portion, and
wherein the frame is provided with a display portion indicative of an order of gripping the first grip portion and the second grip portion.

12. A cartridge according to claim 1, wherein the coupling member is positioned closer to the one end portion than to the other end portion of the frame in the axial direction, and the end portion of the movable member is positioned closer to the other end portion than to the one end portion in the axial direction.

13. A cartridge mountable to an image forming apparatus, the cartridge comprising:
a photosensitive drum;
a coupling member for transmitting a driving force to the photosensitive drum;
a frame rotatably supporting the photosensitive drum;
a grip portion to be gripped when the cartridge is mounted to the image forming apparatus;
a movable member movable relative to the frame; and
a regulating member movable between a regulating position for regulating movement of the movable member by contacting the movable member and a non-regulation position where the moveable member does not regulate the movable member;
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position,
wherein when the regulating member in the regulating position, the movable member is constrained from moving from the first position to the second position, and when the regulating member is in the non-regulating position, the movable member is permitted to move from the first position to the second position, and
wherein, when the movable member is in the second position, the coupling member is closer to one end portion than to the other end portion of the cartridge in the axial direction of the photosensitive drum, and a center of the grip portion is positioned closer to the one end portion than to the other end portion of the cartridge.

14. A cartridge according to claim 13, wherein when the movable member is in the second positioner the grip portion is positioned such that a center position of the cartridge is in a width of the grip portion with respect to the axial direction of the photosensitive drum.

15. A cartridge according to claim 13, wherein the frame includes a toner accommodating container for accommodating toner, and the grip portion is provided on the toner accommodating container.

16. A cartridge according to claim 13, wherein the frame is provided with a recess on an outer surface thereof, and the grip portion includes at least a part of the recess.

17. A cartridge according to claim 13, wherein a surface of the frame which that constitutes-staid the grip portion is provided with a non-slip shape portion.

18. A cartridge according to claim 13, wherein a surface of the frame which that constitutes-staid the grip portion is provided with a plurality of linear ribs.

19. A cartridge according to claim 13, wherein the movable member is rotatable between the first position and the second position.

20. A cartridge according to claim 13, wherein the regulating member is rotatable between the regulating position and the non-regulating position.

21. A cartridge mountable to an image forming apparatus, the cartridge comprising:
a photosensitive drum;
a coupling member for transmitting a driving force to the photosensitive drum;
a frame rotatably supporting the photosensitive drum;
a grip portion to be gripped when the cartridge is mounted to the image forming apparatus;
a movable member movable relative to the frame; and
a regulating member movable between a regulating position for regulating movement of the movable member by contacting the movable member and a non-regulating position where the moveable member does not regulate the movable member,
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position,
wherein when the regulating member in the regulating positioner the movable member is constrained from moving from the first position to the second position, and when the regulating member is in the non-regulating positioner the movable member is permitted to move from the first position to the second position, and
wherein when the movable member is in the second positioner the coupling member is positioned closer to one end portion of the frame than to the other end portion in an axial direction of the photosensitive drum, and a center of the grip portion is positioned closer to the one end portion of the frame than to the other end portion.

22. A cartridge according to claim 21, wherein when the movable member is in the second positioner the grip portion is positioned such that a center position of the cartridge is in a width of the grip portion with respect to the axial direction of the photosensitive drum.

23. A cartridge according to claim 21, wherein the frame includes a toner accommodating container for accommodating toner, and the grip portion is provided on the toner accommodating container.

24. A cartridge according to claim 13, wherein the frame is provided with a recess on an outer surface thereof, and the grip portion includes at least a part of recess.

25. A cartridge according to claim 21, wherein a surface of the frame that constitutes the grip portion is provided with a non-slip shape portion.

26. A cartridge according to claim 21, wherein a surface of the frame that constitutes the grip portion is provided with a plurality of linear ribs.

27. A cartridge according to claim 21, wherein the movable member is rotatable between the first position and the second position

28. A cartridge according to claim 21, wherein the regulating member is rotatable between the regulating position and the non-regulating position.

29. A cartridge mountable to an image forming apparatus, the cartridge comprising:
a photosensitive drum;
a coupling member for transmitting a driving force to the photosensitive drum;
a frame rotatably supporting the photosensitive drum;
a grip portion to be gripped when the cartridge is mounted to the image forming apparatus;
a movable member movable relative to the frame; and
a regulating member movable between a regulating position for regulating movement of the movable member by contacting the movable member and a non-regulating position where the moveable member does not regulate the movable member,
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position,
wherein when the regulating member in the regulating positioner the movable member is constrained from moving from the first position to the second position, and when the regulating member is in the non-regulating position, the movable member is permitted to move from the first position to the second position, and
wherein when the movable member is in the second positioner the coupling member is positioned closer to one end portion of the photosensitive drum than to the other end portion in an axial direction of the photosensitive drum, and a center of the grip portion is positioned closer to the one end portion of the frame than to the other end portion.

30. A cartridge according to claim 29, wherein a cartridge according to claim 13, wherein when the movable member is in the second position, the grip portion is positioned such that a center position of the photosensitive drum is in a width of the grip portion with respect to the axial direction of the photosensitive drum.

31. A cartridge comprising:
a photosensitive drum;
a developing roller for supplying toner to the photosensitive drum,
a coupling member for transmitting a driving force to the photosensitive drum;
a frame rotatably supporting the photosensitive drum;
a movable member movable relative to the frame;
a regulating member including an urged portion and a projected portion projected from the frame, the regulating member being rotatable between a regulating position for regulating movement of the movable member by contacting the movable member and a non-regulating position where the moveable member does not regulate the movable member,
a spring for urging the urged portion to move the regulating member from the non-regulating position to the regulating position,
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position, and
wherein when the regulating member in the regulating positioner the movable member is constrained from moving from the first position to the second position, and when the regulating member is in the non-regulating positioner the movable member is permitted to move from the first position to the second position, and
wherein, as viewed along a direction of a rotational axis of the regulating member, the urged portion is positioned on a side opposite from the projected portion with respect to the a rotational axis of the regulating member in a first direction perpendicular to a direction in which a rotational axis of photosensitive drum and a rotational axis of the developing roller.

32. A cartridge comprising:
a photosensitive drum;
a coupling member for transmitting a driving force to the photosensitive drum;
a frame rotatably supporting the photosensitive drum;
a movable member movable relative to the frame; and
a regulating member rotatable between a regulating position for regulating movement of the movable member by contacting the movable member and a non-regulating position where the moveable member does not regulate the movable member,
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position, and
wherein when the regulating member in the regulating positioner the movable member is constrained from moving from the first position to the second position, and when the regulating member is in the non-regulating positioner the movable member is permitted to move from the first position to the second position, and
wherein the regulating member has a first surface contacting the movable member when the regulating member is in the regulating position, and a second surface contacting the movable member in midstream of movement from the regulating position to the non-regulating position, and
wherein the first surface is substantially perpendicular a rotational axis of the regulating member, and the second surface is inclined relative to the first surface and the rotational axis of the regulating member.

33. A cartridge mountable to an image forming apparatus, the cartridge comprising:
a photosensitive drum;
a coupling member for transmitting a driving force to the photosensitive drum;
a frame rotatably supporting the photosensitive drum;
a developing roller for carrying toner to the photosensitive drum;
a movable member movable relative to the frame; and
a regulating member movable between a regulating position for regulating movement of the movable member by contacting the movable member and a non-regulating position where the moveable member does not regulate the movable member,
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position, and
wherein when the regulating member in the regulating positioner the movable member is constrained from moving from the first position to the second position, and when the regulating member is in the non-regulating positioner the movable member is permitted to move from the first position to the second position,
wherein the coupling member is disposed at a position closer to one end portion of the frame than to the other end portion in an axial direction of the photosensitive drum,
wherein the frame is provided with a first grip portion and a second grip portion to be gripped when the cartridge is mounted to the image forming apparatus,
wherein the first grip portion is positioned closer to the one end portion than the second grip portion, and
wherein the first grip portion is positioned more remote from-aft the rotational axis of the photosensitive drum than the second grip portion in a direction in which the rotational axis of the photosensitive drum and a rotational axis of the developing roller are arranged.

34. A cartridge mountable to an image forming apparatus, the cartridge comprising:
a photosensitive drum;
a coupling member for transmitting a driving force to the photosensitive drum;
a frame rotatably supporting the photosensitive drum;
a movable member movable relative to the frame; and
a regulating member movable between a regulating position for regulating movement of the movable member by contacting the movable member and a non-regulating position where the moveable member does not regulate the movable member;
wherein a position of an end portion of the movable member in an axial direction of the photosensitive drum changes relative to the frame by movement of the movable member between a first position and a second position, and the end portion is closer to the coupling member in the axial direction when the movable member is in the second position than when the movable member is in the first position, and
wherein when the regulating member in the regulating positioner the movable member is constrained from moving from the first position to the second position, and when the regulating member is in the non-regulating positioner the movable member is permitted to move from the first position to the second position,
wherein the coupling member is positioned closer to one end portion of the frame than to the other end portion in an axial direction of the photosensitive drum,
wherein the frame is provided with a first grip portion and a second grip portion to be gripped when the cartridge is mounted to the image forming apparatus,
wherein the first grip portion is positioned closer to the one end portion than the second grip portion, and
wherein the frame is provided with a display portion indicative of an order of gripping the first grip portion and the second grip portion.
